(19) United States
(12) Patent Application Publication
(10) Pub. No.: US 2007/0237372 A1
(43) Pub. Date: Oct. 11, 2007

(54) CROSS-TIME AND CROSS-MODALITY INSPECTION FOR MEDICAL IMAGE DIAGNOSIS

(76) Inventors: Shoupu Chen, Rochester, NY (US); Zhimin Huo, Pittsford, NY (US); Lawrence A. Ray, Rochester, NY (US)

Correspondence Address: PATENT LEGAL STAFF;EASTMAN KODAK COMPANY, 343 STATE STREET, ROCHESTER, NY, 14650-2201, US

(21) Appl. No.: 11/616,320

(22) Filed: Dec. 27, 2006

Related U.S. Application Data
(60) Provisional application No. 60/754,884, filed on Dec. 29, 2005.
(60) Provisional application No. 60/755,156, filed on Dec. 30, 2005.

(51) Int. Cl. G06K 9/00

(52) U.S. Cl. 382/128

(57) ABSTRACT

A cross-time and cross-modality inspection method for medical image diagnosis. A first set of medical images of a subject is accessed wherein the first set is captured at a first time period by a first modality. A second set of medical images of the subject is accessed, wherein the second set is captured at a second time period by a second modality. The first and second sets are each comprised of a plurality of medical image. Image registration is performed by mapping the plurality of medical images of the first and second sets to predetermined spatial coordinates. A cross-time image mapping is performed of the first and second sets. Means are provided for interactive cross-time medical image analysis.

### CROSS REFERENCE TO RELATED APPLICATIONS

Reference is made to, and priority is claimed from, U.S. Provisional Patent Application No. 60/754,884, titled “CROSS-TIME AND CROSS-MODALITY INSPECTION FOR MEDICAL IMAGE DIAGNOSIS” in the names of Chen et al., provisionally filed on Dec. 29, 2005.

Reference is made to U.S. Provisional Patent Application No. 60/755,156, titled “CROSS-TIME INSPECTION FOR MEDICAL IMAGE DIAGNOSIS” in the names of Chen et al., provisionally filed on Dec. 30, 2005.

### FIELD OF THE INVENTION

The present invention relates to a digital image processing method for image analysis and, in particular, to cross-time and cross-modality inspection of tissues of different properties (for example, abnormal and normal tissues) in medical image.

### BACKGROUND OF THE INVENTION

Digital imaging techniques for medical applications were implemented in the 1970′s, for example, with the clinical use of the Computed Tomography (CT) scanner. Since then, use of x-ray imaging and the advent of the digital computer and new imaging modalities (e.g., ultrasound and magnetic resonance imaging (MRI)) have combined to promote diagnostic imaging techniques.

Health care has benefited from the use of digital medical imaging technology. For example, angiographic procedures for viewing blood vessels in the brain, kidneys, arms and legs, and heart have benefited from the adaptation of digital medical imaging and image processing technologies.

With digital images, computerized multi-dimensional (e.g., spatial and temporal) image analysis becomes possible. Multi-dimensional image analysis can be used in applications such as automatic quantification of changes (anatomical or functional) in serial image volume scans of body parts, foreign objects localization, consistent diagnostic rendering, and the like.

In addition, different medical imaging modalities produce images providing different views of human body function and anatomy that have the potential of enhancing diagnostic accuracy dramatically with the help of the right medical image processing software and visualization tools. For example, X-ray computed tomography (CT) and magnetic resonance imaging (MRI) demonstrate brain anatomy but provide little functional information. Positron emission tomography (PET) and single photon emission computed tomography (SPECT) scans display aspects of brain function and allow metabolic measurements but poorly delineate anatomy. Further, CT and MRI images describe complementary morphologic features. For example, bone and calcifications are best seen on CT images, while soft-tissue structures are better differentiated by MRI. Modalities such as MRI and CT usually provide a stack of images for certain body parts.

It is known that the information gained from different dimensions (spatial and temporal) or modalities is often of a difference or complementary nature. Within the current clinical setting, this difference or complementary image information is a component of a large number of applications in clinical diagnostics settings, and also in the area of planning and evaluation of surgical and radiotherapeutical procedures.

In order to effectively use the difference or complementary information, image features from different dimensions or different modalities are superimposed to each other by physicians using a visual alignment system. Unfortunately, such a coordination of multiple images with respect to each other is extremely difficult and even highly trained medical personnel, such as experienced radiologists, have difficulty in consistently and properly interpreting a series of medical images so that a treatment regime can be instituted which best fits the patient's current medical condition.

Another problem encountered by medical personnel is the large amount of data and numerous images that are obtained from current medical imaging devices. The number of images collected in a standard scan can be in excess of 100, and frequently number in the many hundreds. In order for medical personnel to properly review each image takes a great deal of time and, with the many images that current medical technology provides, a great amount of time is required to thoroughly examine all the data.

Accordingly, there exists a need for an efficient approach that uses image processing/computer vision techniques to automatically detect/diagnose diseases.

U.S. Published Application No. 2004/0064037 (Smith), incorporated herein by reference, is directed to a rule-based approach for processing medical images. Its technique applies pre-programmed rules that specify the manner in which medical image data is to be classified or otherwise processed. The programmed rules can include rules selected from available rules, modify/customize them to generate new rules, or provide completely new rules. However, Smith's technique fails to teach how to inspect cross-time, cross-modality medical images for a patient so that reliable and accurate diagnoses and surgical plan can be performed.

U.S. Published Application No. 2003/0095147 (Daw), incorporated herein by reference, relates to a user interface having analysis status indicators. Daw describes a method of medical image processing and visualization. When such data analysis are performed on the images, analysis indicators are provided in the upper left hand corner of the display providing a view indication of the results and status of any computer analysis being performed or that has been performed on the data. Daw's system does not provide a function to automatically detect and differentiate image areas corresponding to materials (tissues) being imaged that have different time response to contrast enhancing agent. Applicants note that such a function is particularly useful in diagnosing malignant and benign breast tumors using MRI contrast enhanced images.

U.S. Pat. No. 6,353,803 (Degani), incorporated herein by reference, is directed to an apparatus and method for monitoring a system in which a fluid flows and which is characterized by a change in the system with time in space. A preselected place in the system is monitored to collect data at two or more time points correlated to a system event. The data is indicative of a system parameter that varies with time as a function of at least two variables related to system wash-in and wash-out behavior.

Studies of such curves/parameters has been used clinically to identify and characterize tumors into malignant or benign classes, although the success has been variable with generally good sensitivity but often very poor specificity (for example, refer to S. C. Rankin “MRI of the breast”, Br. J. Radiol 73, pp 806-818, 2000).

While such systems may have achieved certain degrees of success in their particular applications, there is a need for an improved digital image processing method for medical image analysis that overcomes the problems set forth above and addresses the utilitarian needs set forth above.

The present invention provides a method for image analysis and, in particular, for cross-time and cross-modality inspection of tissues of different properties (for example, abnormal and normal tissues) in medical image.

### SUMMARY OF THE INVENTION

An object of the present invention is to provide a method for cross-time and cross-modality inspection of tissues of different properties (for example, abnormal and normal tissues) in medical images.

Any objects provided are given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

The present invention provides a image processing/pattern recognition method for cross-time and cross-modality inspection of tissues of different properties (for example, abnormal and normal tissues) in medical images. The method includes the steps of optionally classifying tissue properties in cross-time medical image sequences; performing cross-time cross-modality image mapping; and performing interactive cross-time cross-modality medical image inspection.

According to one aspect of the invention, there is provided a method of cross-time inspection of tissues of different properties in cross-time medical image sequences. The method includes the steps of: acquiring a plurality of medical image (e.g. MRI images before and after the injection of contrast enhancement agent) cross-time sequences; performing intra-registration of the plurality of medical image cross-time sequences with respect to spatial coordinates; performing inter-registration of the plurality of medical image cross-time sequences with respect to spatial coordinates; classifying tissues of different properties for the registered plurality of medical image cross-time sequences; and presenting the classification results for cross-time inspection.

According to another aspect of the invention, there is provided a method for automatic abnormal tissue detection and differentiation using contrast enhanced MRI images augmented with other physical or non-physical factors. The method includes the steps of acquiring a plurality of MRI breast image sets; aligning the plurality of MRI breast images with respect to spatial coordinates; differencing the plurality of MRI breast image sets with a reference MRI image set, producing a plurality of difference image sets; segmenting the plurality of difference image sets, producing a plurality of MRI breast images with segmented intensity pixels; applying dynamic system identification to the segmented intensity pixels, producing a plurality of dynamic system parameters; and classifying the plurality of system parameters augmented with other physical or non-physical factors into different classes.

According to still another aspect of the invention, there is provided a method for automatic material classification. The method includes the steps of: acquiring a plurality of image sets of an object sequentially in time; aligning the plurality of image sets with respect to spatial coordinates; differencing the plurality of image sets with a reference image set to produce a plurality of difference image sets; segmenting the plurality of difference image sets to produce a plurality of images with segmented intensity pixels; applying dynamic system identification to the segmented intensity pixels of the plurality of images to produce a plurality of dynamic system parameters; and classifying the plurality of system parameters into different classes.

According to another aspect of the invention, there is provided a method for abnormal tissue detection using contrast enhanced MRI images. The method includes the steps of: acquiring a plurality of MRI breast image sets sequentially in time; aligning the plurality of MRI breast image sets with respect to spatial coordinates; differencing the plurality of MRI breast image sets with a reference MRI image set to produce a plurality of difference image sets; segmenting the plurality of difference image sets to produce a plurality of MRI breast image sets with segmented intensity pixels; applying a dynamic system identification to the segmented intensity pixels of the plurality of MRI breast image sets to produce a plurality of dynamic system parameters; and classifying the plurality of system parameters into different classes to detect abnormal tissue.

### BRIEF DESCRIPTION OF THE DRAWINGS

The foregoing and other objects, features, and advantages of the invention will be apparent from the following more particular description of the embodiments of the invention, as illustrated in the accompanying drawings. The elements of the drawings are not necessarily to scale relative to each other.

FIG. 1 is a graph illustrating dynamic contrast uptake properties (curves) for different breast tissues.

FIG. 2 is a schematic diagram of an image processing system useful in practicing the method in accordance with present invention.

FIG. 3 is a flowchart illustrating a method of cross-time and cross-modality inspection of medical images in accordance with the present invention.

FIG. 4 is a flowchart illustrating one embodiment of the cross-time tissue property inspection method in accordance with the present invention.

FIG. 5 is a flowchart illustrating a method of image registration in accordance with the present invention.

FIG. 6 is a graph illustrating image registration concept.

FIG. 7 is a graph illustrating two cross-time image sequences.

FIG. 8 is a flow chart illustrating one embodiment of the automatic abnormal tissue detection method in accordance with the present invention.

FIG. 9 is a graph illustrating dynamic contrast uptake properties (curves) for malignant and benign tumor tissues.

FIG. 10 is a schematic diagram illustrating the concept of step function response and system identification.

FIG. 11 is a flowchart illustrating a method of system identification in accordance with the present invention.

FIG. 12 is a graph illustrating a method of cross-time tissue property inspection visualization presentations of the present invention.

FIG. 13 is a graph illustrating tissues with different properties in medical images.

FIGS. 14A-14E show a collection of graphs illustrating steps of 3D image volume projections of the present invention.

FIG. 15 is a graph illustrating a slice with a cloud of pixels.

FIG. 16 is a collection of medical 3D volume projections.

FIG. 17 is a graph illustrating one embodiment of cross-time and cross-modality medical image inspection in accordance with the present invention.

### DETAILED DESCRIPTION OF THE INVENTION

The following is a detailed description of the preferred embodiments of the invention, reference being made to the drawings in which the same reference numerals identify the same elements of structure in each of the several figures.

The inspection of cross-time, cross-modality medical images for a patient can assist in providing reliable and accurate diagnoses and surgical planning. For example, X-ray mammography has limited specificity and sensitivity. It is reported that 5%- 15% of cancers are missed using X-ray mammograms. MRI mammography, as an alternative imaging method, has a high sensitivity for tumors larger than 3 mm.

It is known that malignant breast tumors begin to grow their own blood supply network once they reach a certain size; this is the way the cancer can continue to grow. In a breast MRI scan, a contrast agent injected into the bloodstream can provide information about blood supply to the breast tissues; the agent “lights up” a tumor by highlighting its blood vessel network. Usually, several scans are taken: one before the contrast agent is injected and at least one after. The pre-contrast and post-contrast images are compared and areas of difference are highlighted. It should be recognized that if the patient moves even slightly between the two scans, the shape or size of the image may be distorted, resulting in a loss of information.

A contrast agent for MRI is Gadolinium or gadodiamide, and provides contrast between normal tissue and abnormal tissue in the brain and body. Gadolinium looks clear like water and is non-radioactive. After it is injected into a vein, Gadolinium accumulates in the abnormal tissue that may be affecting the body or head. Gadolinium causes these abnormal areas to become bright (enhanced) on the MRI. This makes it easy to see. Gadolinium is then cleared from the body by the kidneys. Gadolinium allows the MRI to define abnormal tissue with greater clarity. Tumors enhance after Gadolinium is given. The exact size of the tumor and location is important in treatment planning and follow up. Gadolinium is also helpful in finding small tumors by making them bright and easy to see.

Dynamic contrast enhanced MRI is used for breast cancer imaging; in particular for those situations that have an inconclusive diagnosis based on x-ray mammography. The MRI study can involve intravenous injection of a contrast agent (typically gadopentetate dimeglumine) immediately prior to acquiring a set of Ti-weighted MR volumes with a temporal resolution of around a minute. The presence of contrast agent within an imaging voxel results in an increased signal that can be observed over the time course of the study.

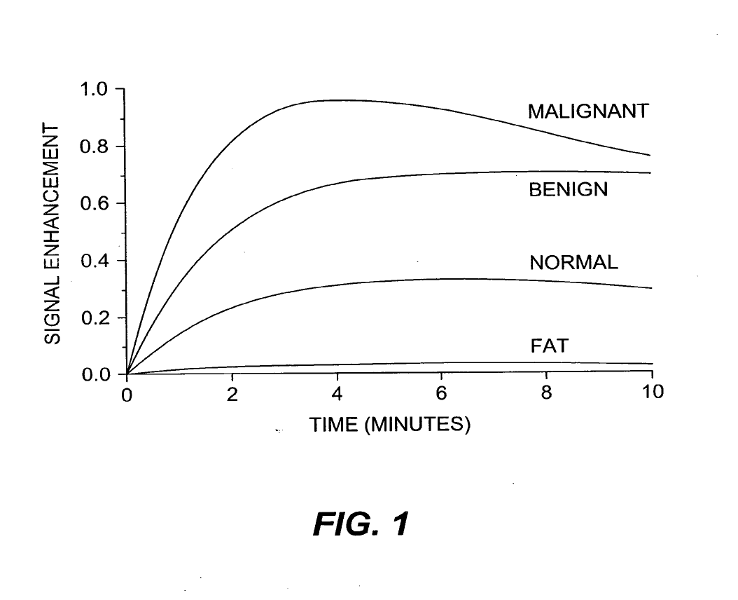

A study of these signal-time curves enables identification of different tissue types due to their differential contrast uptake properties as illustrated in FIG. 1. It is noted that, typically, cancerous tissue shows a high and fast uptake due to a proliferation of “leaky” angiogenic microvessels, while normal and fatty tissues show little uptake. The uptake (dynamic) curves have often been fitted using a pharmacokinetic model to give a physiologically relevant parameterisation of the curve (refer to P. S. Tofts, B. Berkowitz, M. Schnall, “Quantitative analysis of dynamic Gd-DTPA enhancement in breast tumours using a permeability model”, Magn Reson Med 33, pp 564-568, 1995).

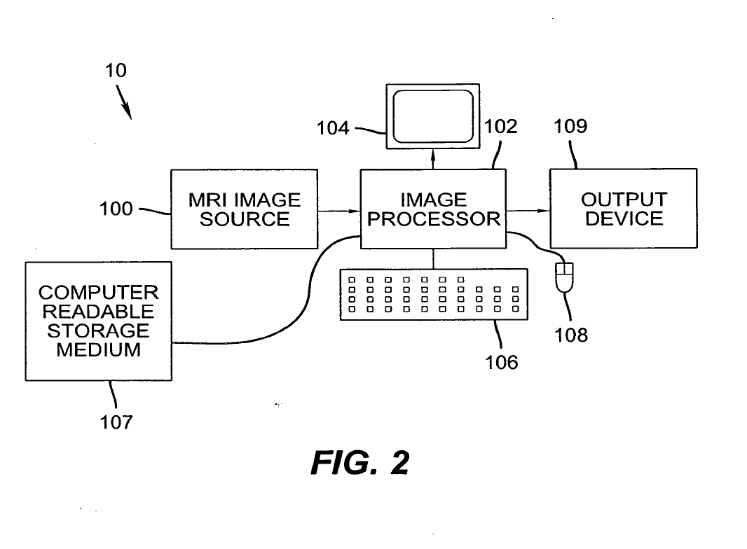

FIG. 2 shows an image processing system 10 useful in practicing the method in accordance with the present invention. System 10 includes a digital MRI image source 100, for example, an MRI scanner, a digital image storage device (such as a compact disk drive), or the like. The digital image from digital MRI image source 100 is provided to an image processor 102, for example, a programmable personal computer, or digital image processing work station such as a Sun Sparc workstation. Image processor 102 can be connected to a display 104 (such as a CRT display or other monitor), an operator interface such as a keyboard 106, and a mouse 108 or other known input device. Image processor 102 is also connected to computer readable storage medium 107. Image processor 102 transmits processed digital images to an output device 109. Output device 109 can comprise a hard copy printer, a long-term image storage device, a connection to another processor, an image telecommunication device connected, for example, to the Internet, or the like.

In the following description, an embodiment will be described as a method. However, in another embodiment, the present invention comprises a computer program product for detecting abnormal tissues in a digital MRI image in accordance with the method described. In describing the present invention, it should be recognized that the computer program of the present invention can be utilized by any well-known computer system, such as the personal computer shown in FIG. 2. However, other types of computer systems can be used to execute the computer program of the present invention. For example, the method of the present invention can be executed in the computer contained in a digital MRI machine or a PACS (picture archiving communication system). Consequently, the computer system will not be discussed in further detail herein.

It will be further recognized that the computer program product of the present invention can make use of image manipulation algorithms and processes that are well known. Accordingly, the present description will be directed in particular to those algorithms and processes forming part of, or cooperating more directly with, the method of the present invention. Thus, it will be understood that the computer program product embodiment of the present invention may embody algorithms and processes not specifically shown or described herein that are useful for implementation. Such algorithms and processes are conventional and within the ordinary skill in such arts.

Other aspects of such algorithms and systems, and hardware and/or software for producing and otherwise processing the images involved or co-operating with the computer program product of the present invention, are not specifically shown or described herein and can be selected from such algorithms, systems, hardware, components, and elements known in the art.

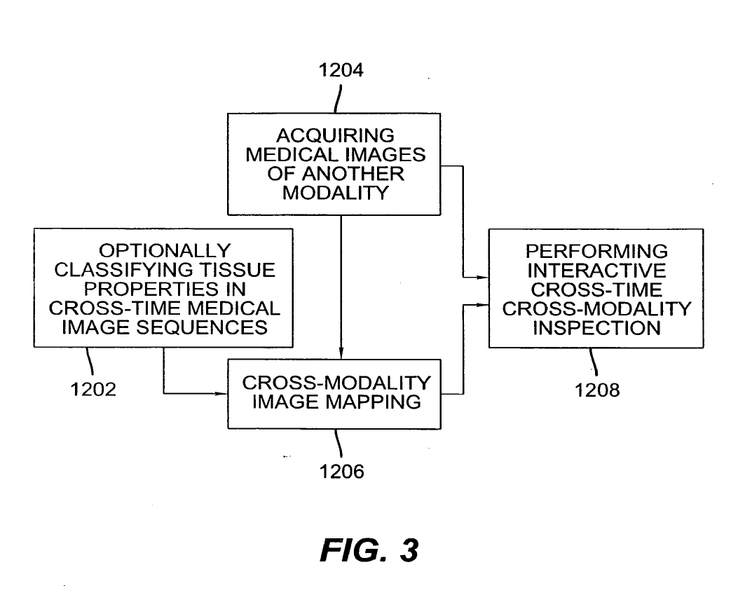

FIG. 3 generally illustrates a method of cross-time cross-modality medical image inspection of tissues of different properties in medical images. More particularly, FIG. 3 shows a flow chart illustrating one embodiment of the method of cross-time cross-modality medical image inspection of tissues of different properties. In the embodiment shown in FIG. 3, a plurality of multi-modal medical images goes through a series of processes. These processes perform specific functionalities including acquiring medical images of one modality, acquiring medical images of another modality 1204, cross-modality image mapping 1206, optionally classifying tissue properties in cross-time medical image sequences 1202, and performing interactive cross-time cross-modality inspection 1208.

Each of the processes shown in FIG. 3 will be described below in more detail. It is noted that the medical image sequences used in step 1202 may or may not be acquired with contrast enhancement agent administrated. If a medical image sequence is acquired without contrast enhancement agent administrated, no classification of tissue properties needs to be performed in step 1202.

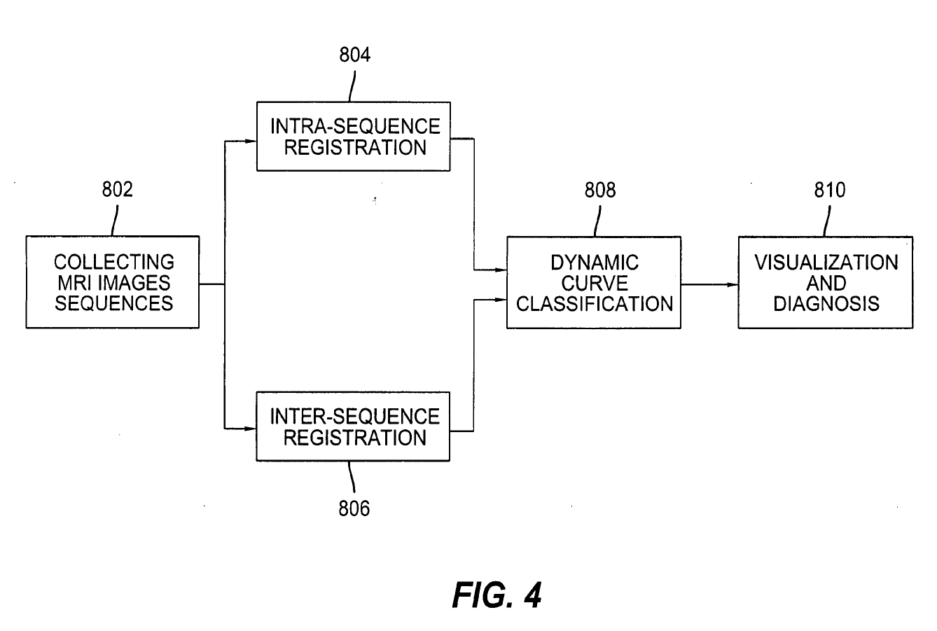

Referring now to FIG. 4, the method of cross-time inspection of tissues of different properties in medical images as a time function will be outlined. FIG. 4 is a flow chart illustrating one embodiment of the method of the cross-time inspection of tissues of different properties in medical images of the present invention. In the embodiment shown in FIG. 4, a plurality of medical image cross-time sequences goes through a series of processes 802. Each of these processes performs a specific functionality such as intra-sequence registration 804, inter-sequence registration 806, dynamic curve classification 808, and visualization and diagnosis 810.

The concept of image registration will now be introduced.

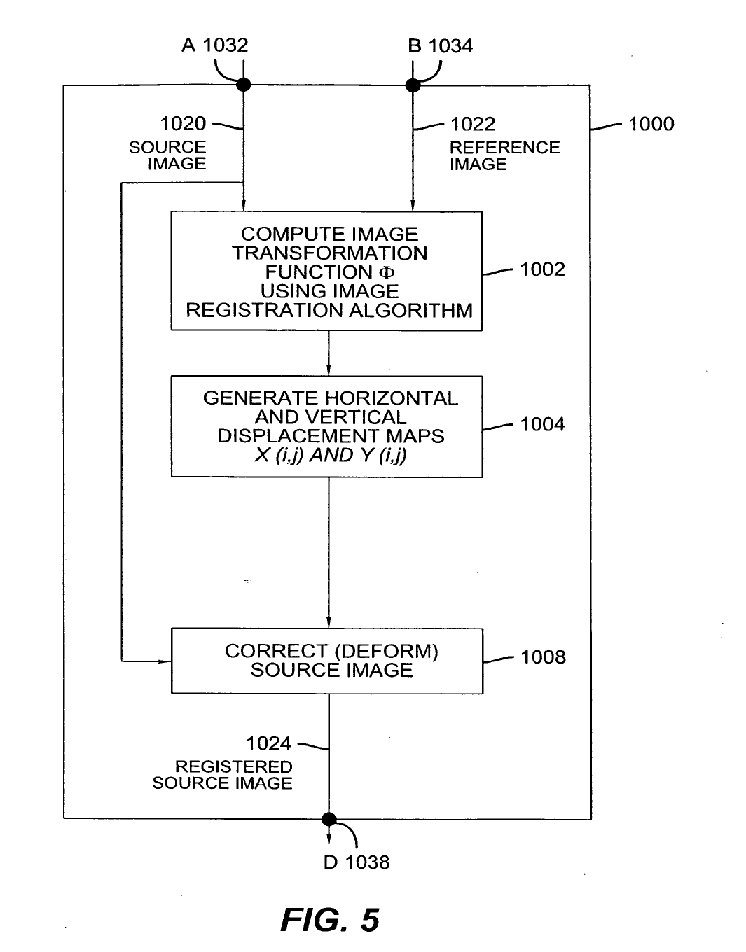

Referring now to FIG. 5, there is shown a flow chart of the method of a generic image registration process. The intent of image registration is to determine a mapping between the coordinates in one space (a two dimensional image) and those in another (another two dimensional image), such that points in the two spaces that correspond to the same feature point of an object are mapped to each other. The process of determining a mapping between the coordinates of two images provides a horizontal displacement map and a vertical displacement map of corresponding points in the two images. The vertical and horizontal displacement maps are then used to deform one of the involved images to minimize the misalignment between the two.

In terms of image registration terminology, the two images involved in registration process are referred to as a source image 1020 and a reference image 1022. For purposes of discussion, denote the source image and the reference image by I(xₜ, yₜ, t) and I(xₜ₊₁, yₜ₊₁, t+1) , respectively. The notations x and y are the horizontal and vertical coordinates of the image coordinate system, and t is the image index (image 1, image 2, etc.). The origin, (x=0, y=0) , of the image coordinate system is defined at the center of the image plane. It should be noted that the image coordinates, x and y, are not necessarily integers.

For the convenience of implementation, the image (or image pixel) is also indexed as I(i, j) where i and j are strictly integers and parameter t is ignored for simplicity. This representation aligns with indexing a matrix in the discrete domain. If the image (matrix) has a height of h and a width of w, the corresponding image plane coordinates, x and y, at location (i, j) can be computed as x=i−(w−1)/2.0, and y=(h−1)/2.0−j. The column index i runs from 0 to w−1. The row index j runs from 0 to h−1.

In general, the registration process is to find an optimal transformation function Φₜ₊₁(xₜ, yₜ) (see step 1002) such that
[xₜ₊₁, yₜ₊₁, 1]^{T}=Φₜ₊₁(xₜ, yₜ)[xₜ, yₜ, 1]^{T} (10-1)

The transformation function of Equation (10-1) is a 3×3 matrix with elements shown in Equation (10-2).

$$Φ = [ \begin{matrix}{ϕ}_{00} & {ϕ}_{01} & {ϕ}_{02} \\ {ϕ}_{10} & {ϕ}_{11} & {ϕ}_{12} \\ 0 & 0 & 1\end{matrix} ] \qquad ( 10 \text{-} 2 )$$

The transformation matrix is comprised of two parts, a rotation sub-matrix

$$[ \begin{matrix}{ϕ}_{00} & {ϕ}_{01} \\ {ϕ}_{10} & {ϕ}_{11}\end{matrix} ]$$

and a translation vector

$$[ \begin{matrix}{ϕ}_{02} \\ {ϕ}_{12}\end{matrix} ] .$$

Note that the transformation function Φ is either a global function or a local function. A global function Φ transforms every pixel in an image in a same way. A local function Φ transforms each pixel in an image differently based on the location of the pixel. For the task of image registration, the transformation function Φ could be a global function or a local function or a combination of the two.

In practice, the transformation function Φ generates two displacement maps (step 1004), X(i, j), and Y(i, j), which contain the information that could bring pixels in the source image to new positions that align with the corresponding pixel positions in the reference image. In other words, the source image is to be spatially corrected in step 1008 and become a registered source image 1024. For both displacement maps, X(i, j) and Y(i, j) , the column index i runs from 0 to w−1 and the row index j runs from 0 to h−1.

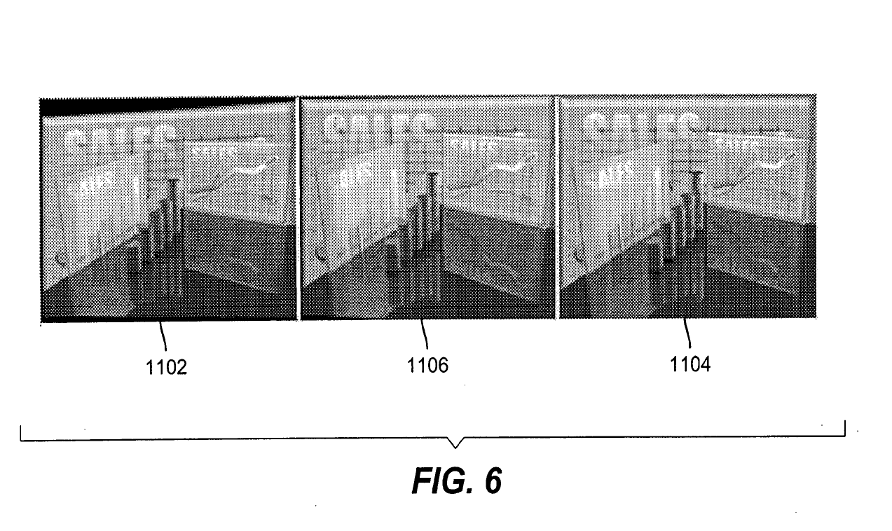

An exemplary result of misalignment correction is shown in FIG. 6. Shown in this figure is a source image 1102, and a reference image 1106. There are varying vertical misalignments between source image 1102 and reference image 1106. By applying the steps shown in FIG. 5 to these two images, a vertical misalignment corrected source image is obtained, shown in FIG. 6 as image 1104.

Note that the registration algorithm used in computing the image transformation function Φ could be a rigid registration algorithm, a non-rigid registration algorithm, or a combination of the two. Those skilled in the art understand that there are numerous registration algorithms that can carry out the task of finding the transformation function Φ that generates the needed displacement maps for the correction of the misalignment in two relevant images. Exemplary registration algorithms can be found in “Medical Visualization with ITK”, by Lydia Ng, et al. at http://www.itk.org. Also, those skilled in the art understand that spatially correcting an image with a displacement map could be realized by using any suitable image interpolation algorithms (see for example, “Robot Vision” by Berthold Klaus Paul Horn, The MIT Press Cambridge, Mass.)

Referring again to FIG. 5, with the present invention, the above discussed image registration process can be viewed as a black box 1000 with input terminal A (1032), input terminal B (1034) and output terminal D (1036). Box 1000 will be used in the following description of the present invention of cross-time inspection of tissues with different properties.

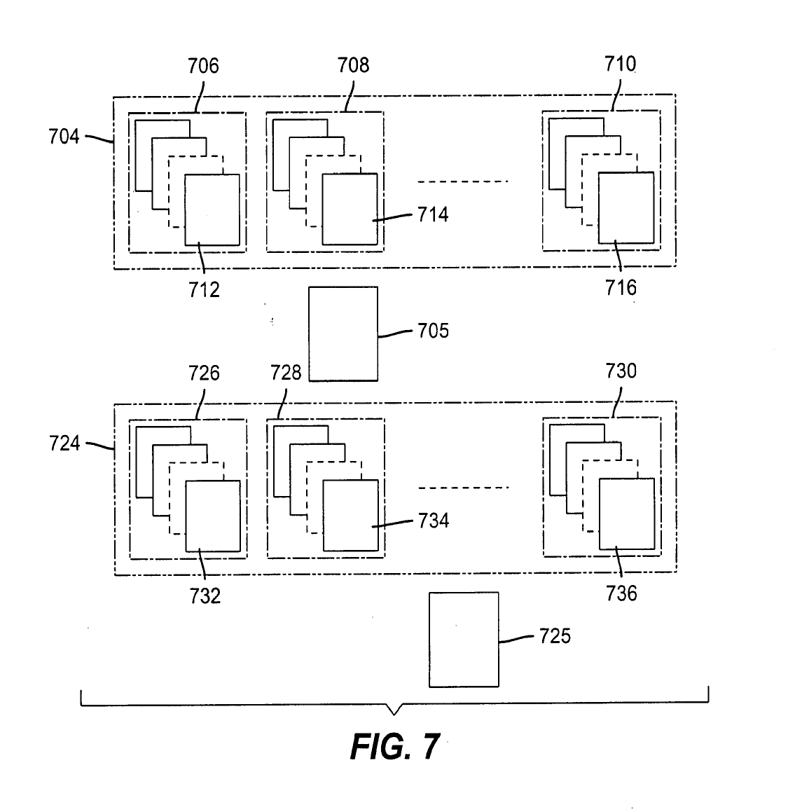

The processes of intra-sequence 804 and inter-sequence 806 registration shown in FIG. 4 will now be more particularly described with reference to FIG. 7.

Exemplary MRI image sequences for an object (a breast, for example) are depicted in FIG. 7. An MRI image sequence 704 includes an exemplary collection of MRI slice sets 706, 708 and 710 for the same object (e.g., the breast). Each MRI slice set includes a number of slices that are images (cross-sections) of the object (the breast). Exemplary slices shown in FIG. 7 are a slice (image) 712 for set 706, a slice (image) 714 for set 708, and a slice (image) 716 for set 710.

Purposely, MRI slice sets are taken at different times to capture functional changes of the object in time space when contrast enhancement agent is administrated. Exemplary time gaps between the MRI slice sets could be 1 minute, 2 minutes, and the like.

For cross-time inspection of tissues with different properties, besides sequence 704, one or more sequences of MRI image for the same object (the breast) are needed. An exemplary MRI sequence 724 is such a sequence. Sequence 724 is captured at a different time from sequence 704. Exemplary time gap between sequence 724 and sequence 704 could be several months.

Similar to sequence 704, sequence 724 includes an exemplary collection of MRI slice sets 726, 728 and 730 for the same object (the breast). Each MRI slice set contains a number of slices that are images (cross-sections) of the object (the breast). Exemplary slices are a slice (image) 732 for set 726, a slice (image) 734 for set 728, and a slice (image) 736 for set 730.

As indicated above, MRI slice sets are taken at different time to capture functional changes of the object in time space. Exemplary time gap between the MRI slice sets could be 1 minute, 2 minutes, or the like.

An intra-sequence registration (804) is defined as registering slices (images) of the same cross-section of an object within a sequence of MRI image sets. For example, slices (images) 712, 714, and 716 for sequence 704, and slices (images) 732, 734, and 736 for sequence 724.

An embodiment of intra-sequence registration is discussed in the context of the method of tissue property inspection of a set of images, which acts as an independent entity. The need of intra-sequence registration occurs since during the process of capturing MRI images, due the inevitable object (breast, for example) motion, images (for example, 712, 714 and 716) for the same cross-section of the object present misalignment. This misalignment can cause errors in the process of tissue property inspection.

As stated previously, for cross-time inspection of tissues with different properties, two or more image sequences (such as sequences 704 and 724) obtained at different times are required for the same object. Corresponding slices (such as slices 712 and 732) in different sequences are most likely misaligned and may have somehow different shapes. An inter-sequence registration (806) is thus needed and defined as registering slices (images) of the same cross-section of an object from different sequences. Exemplary pairs of slices to be inter-registered are pairs 712 and 732, pairs 714 and 734, and pairs 716 and 736.

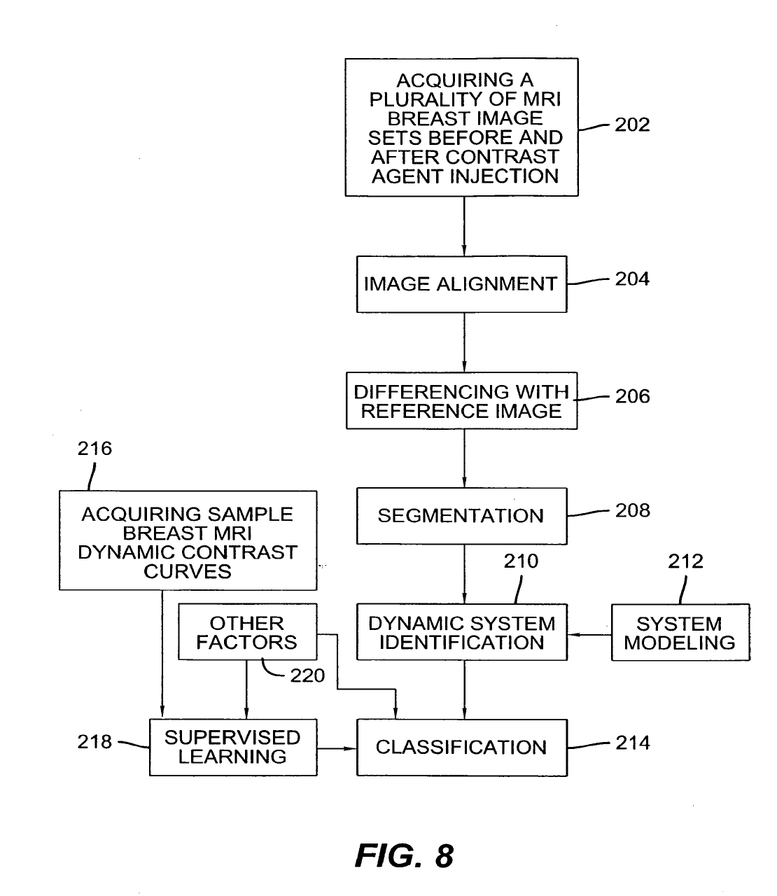

Turning now to FIG. 8, a method of tissue property inspection of a set of images (also step 808, dynamic curve classification) will be outlined. FIG. 8 is a flow chart illustrating one embodiment of the automatic abnormal tissue detection method of the present invention. Note that the flow chart illustrated in FIG. 8 serves as an independent entity that constitutes a self-contained process. Therefore, the flow chart illustrated in FIG. 8 is not interpreted as an expansion of step 808. Rather, step 808 and step 804 are explained using the steps shown in the flow chart in FIG. 8.

In the embodiment shown in FIG. 8, a plurality of MRI breast images sets acquired before and after contrast agent injection go through a series of processes. Each of these processes performs a specific functionality such as alignment, subtraction, segmentation, system identification, and classification. In the present invention, abnormal tissue detection tasks are accomplished by a means of dynamic system parameter classification.

In the embodiment shown in FIG. 8, a first step 202 (related to step 802 of FIG. 4 and step 1202 of FIG. 3) is employed for acquiring a plurality of MRI breast image sets before and after an injection of contrast enhancement agent at one time. For cross-time cross-modality inspection, step 202 repeats to acquire another plurality of MRI breast image sets before and after an injection of contrast enhancement agent at another time. Those skilled in the art will understand that for cross-modality inspection, medical image sequences obtained (step 202) at different times can contain only one set image slices in each sequence (e.g. 706 for sequence 704, 726 for sequence 726) without the injection of contract enhancement agent. In the former case (with injection), step 1202 performs acquiring medical image sequences and the classifying tissue properties in cross-time medical image sequences. In the latter case (without injection), step 1202 performs the acquisition of medical image sequences; accordingly, steps 804 and 808 will be skipped. The following detailed description is for the cases in which contrast enhancement agent is administrated.

Denote I₀(x, y, z) as a set of MRI image for a breast with a number of images (slices) in a spatial order before an injection of contrast agent, where z ∈[1, . . . S] is the spatial order index, s is the number of images in the set, x and y are the horizontal and vertical indices respectively for an image where x ∈[1, . . . X] and y ∈[1, . . . Y]. After the administration of contrast agent, a plurality of MRI image sets is acquired with the same number (S) of images of the same breast for each set in the same spatial order z . The plurality of MRI image sets is taken with a temporal resolution, for example, of around one minute. This MRI image sets can be expressed by Iₖ(x, y, z) where k is the temporal order index and k ∈[1, . . . K]; K is the number of sets. Exemplary sets are 706, 708 and 710, (three sets, K=3), or sets 726, 728 and 730, (three sets, K=3). An exemplary slice Iₖ(x, y, 1) (at location 1) for set 706 (the first set for sequence 704, k=1) is slice 712.

The presence of a contrast agent within an imaging voxel results in an increased signal that can be observed over the time course of the image acquisition process. Study of these signal-time curves enables identification of different tissue types due to their differential contrast uptake properties. For the purpose of automatic detection of abnormal tissues, the K sets of MRI images, Iₖ(x, y, z) , taken after the injection of contrast agent have to be spatially aligned (misalignment correction), in a step 204 (also step 804 intra-sequence registration), with a reference set of MRI images with respect to spatial coordinates x, y . In general, the reference set of MRI image is the set of MRI images, I₀(x, y, z) , taken before the injection of the contrast agent. The alignment process ensures that pixels belong to a same tissue region of the breast have the same x, y coordinates in all the K sets of images. The alignment process executes the following:

for k = 1 : K

for z = 1 : S

align(Iₖ(x,y,z),I₀(x,y,z))

end

end

Using black box 1000 (refer to FIG. 5), Iₖ(x, y, z) is input to terminal A (1032), I₀(x, y, z) is input to terminal B (1034) and the registered image of Iₖ(x, y, z) is obtained at output terminal D (1038).

An exemplary method employable to realize the alignment function, align (A, B), is a non-rigid registration that aligns terminal A with terminal B and is widely used in medical imaging and remote sensing fields. The registration process (misalignment correction) has been discussed previously. Those skilled in the art will recognize that other registration methods can also be used.

As was discussed with reference to FIG. 1, after the injection of contrast agent, image pixel intensity increases differently for different breast tissues. This phenomenon indicates that subtracting the image taken before the injection from the image taken after the injection will provide radiologists with clearer information of locations of abnormal tissues in the image. This information can also be used to extract regions from the original MRI breast images for automatic abnormal tissue detection and differentiation. This information is obtained in step 206 in FIG. 8 that carries out differencing the plurality of MRI breast image sets, Iₖ(x, y, z), k ∈[1, . . . K] with a reference MRI image set to produce a plurality of difference image sets, δIₖ(x, y, z), k ∈[1, . . . K]. The set of MRI images, I₀(x, y, z), is selected as intensity reference images. The differencing process is executed as:

for k = 1 : K

for z = 1 : S

δIₖ (x,y,z) = subtraction(Iₖ (x,y,z),I₀(x,y,z))

end

end

wherein the function, subtraction(A, B), subtracts B from A.

In FIG. 3 at step 208, the difference images, δIₖ(x, y, z), are subject to a segmentation process that first evaluates the plurality of difference image sets δIₖ(x, y, z), and produces a plurality of mask image sets, Mₖ(x, y, z), k ∈[1, . . . K] obtained by executing:

for k = 1 : K

for z = 1 : S

for x = 1 : X

for y = 1 : Y

if δI ₖ (x,y,z) > T

M ₖ (x,y,z) = 1

end

end

end

end

end

wherein mask image sets, Mₖ(x, y, z), k ∈[1, . . . K], are initialized with zeros, T is a statistical intensity threshold. An exemplary value of T is an empirical value 10.

The segmentation process in step 208 segments the images in the plurality of MRI breast image sets, Iₖ(x, y, z), according to the non-zero pixels in the mask images, Mₖ(x, y, z), to obtain segmented intensity pixels in the images of the plurality of MRI breast image sets. Denoting the resultant images by Sₖ(x, y, z), k ∈[1, . . . K], the segmentation operation can be expressed as:

for k = 1 : K

for z = 1 : S

for x = 1 : X

for y = 1 : Y

if M ₖ (x,y,z) = 1

S ₖ (x,y,z) = I ₖ (x,y,z)
end

end

end

end

end

wherein images, Sₖ(x, y, z), are initialized as zeros.

Those skilled in the art will recognize that, in practical implementation, the stage of generating mask images can be omitted and the segmentation process can be realized by executing:

for k =1 : K

for z = 1 : S

for x = 1 : X

for y = 1 : Y

if δI ₖ (x,y,z) > T

S ₖ (x,y,z) = I ₖ (x,y,z)
end

end

end

end

end

wherein images, Sₖ(x, y, z), are initialized as zeros.

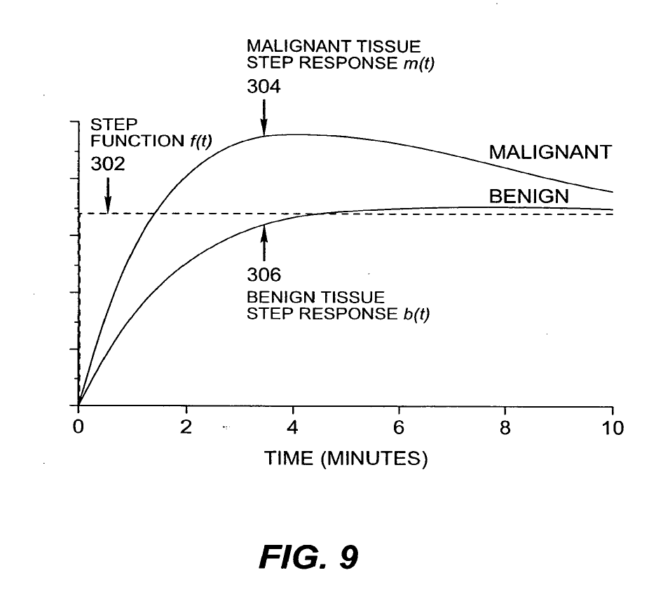

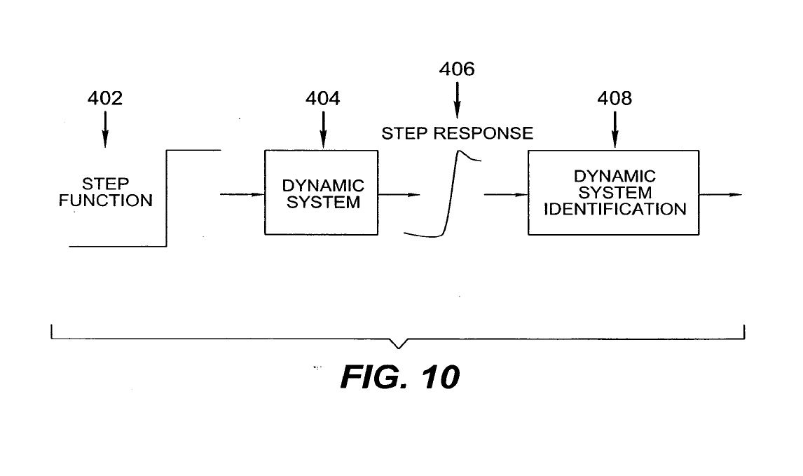

Step 210 of FIG. 8 is a dynamic system identification step, which is described with reference to FIGS. 9 and 10. In FIG. 9, there is shown a chart that is a replica to the chart shown in FIG. 1 except that FIG. 9 includes the insertions of a step function, f(t), curve 302 and the removal of the normal and fat tissue curves.

It is the intention of the present invention to detect abnormal tissues and more importantly to differentiate Malignant from Benign tissues. (Note: the step function, f(t), is defined as f(t<0)=0; f(t≧0)=|λ|; λ≢0). Pixels that belong to normal and fat tissues are set to zeros in images Sₖ(x, y, z) in the segmentation step 208. The remaining pixels in images Sₖ(x, y, z) belong to either malignant or benign tissues.

It is difficult to differentiate malignant tissue from benign tissue by solely assessing the pixels brightness (intensity) in a static form, that is, in individual images. However, in a dynamic form, the brightness changes present a distinction between these two types of tissues. As shown in FIG. 9, starting from time zero, the brightness (contrast) curve 304, m(t), of the malignant tissue rises quickly above the step function curve 302 and then asymptotically approaches the step function curve 302; while the brightness (contrast) curve 306, b(t), of the benign tissue rises slowly underneath the step function curve 302 and then asymptotically approaches the step function curve, f(t), 302.

Those skilled in the art can recognize that the brightness (contrast) curve 304, m(t), resembles a step response of an underdamped dynamic system, while the brightness (contrast) curve 306, b(t), resembles a step response of an overdamped dynamic system.

An exemplary generic approach to identifying a dynamic system behavior is generally depicted in FIG. 10. For an unknown dynamic system 404, a step function 402 is used as an excitation. A response 406 to the step function 402 from the dynamic system 404 is fed to a system identification step 408 in order to estimate dynamic parameters of system 404.

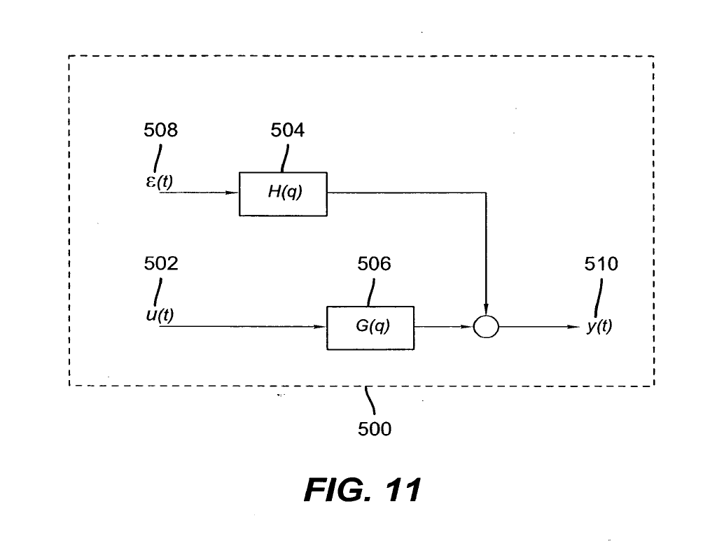

As shown in FIG. 8, system modeling of dynamic system identification 210 can be accomplished at step 212. An exemplary realization of dynamic system modeling 212 is shown in FIG. 11 where it is shown an ARX (autoregressive) model 500 (refer to “System identification Toolbox”, by Lennart Ljung, The Math Works).

A general ARX model can be expressed as the equation:
y(t)=G(q)f(t)+H(q)ε(t) (1)
where G(q) (506) and H(q) (504) are the system transfer functions as shown in FIG. 11, u(t) (502) is the excitation, ε(t) (508) is the disturbance, and y(t) (510) is the system output. It is known that the transfer functions G(q) (506) and H(q) (504) can be specified in terms of rational functions of q⁻¹ and specify the numerator and denominator coefficients in the forms:

$$\begin{matrix}G ( q ) = {q}^{- nk} \frac{B ( q )}{A ( q )} & ( 2 ) \\ H ( q ) = \frac{1}{A ( q )} & ( 3 )\end{matrix}$$

wherein A and B are polynomials in the delay operator q⁻¹:
A(q)=1+a₁q⁻¹+. . . +aₙₐq^{-na} (4)
B(q)=b₁+b₂q⁻¹+. . . +a_{nb}q^{-nb+1} (5)

When A and B are polynomials, the ARX model of the system can be explicitly rewritten as:
y(t)=−a₁y(t−1)−. . . −aₙₐy(t−na)+b₁u(t−nk)+. . . b_{nb}u(t−nk−nb+1)+e(t) (6)
Equation (6) can be further rewritten as a regression as:

$$y ( t ) = {φ ( t )}^{T} θ \\ where φ ( t ) = [ \begin{matrix}- y ( t - 1 ) \\ ⋮ \\ - y ( t - na ) \\ u ( t - nk ) \\ ⋮ \\ u ( t - nk - nb + 1 )\end{matrix} ] and θ = [ \begin{matrix}{a}_{1} \\ ⋮ \\ {a}_{na} \\ {b}_{1} \\ ⋮ \\ {b}_{nb}\end{matrix} ] \qquad ( 7 )$$

The system identification solution for the coefficient vector θ is

$$\begin{matrix}\hat{θ} = {( {Φ}^{T} Φ )}^{- 1} {Φ}^{T} Y & ( 8 ) \\ where & \\ Φ = [ \begin{matrix}{Φ}^{T} ( {t}_{0} ) \\ ⋮ \\ {φ}^{T} ( {t}_{0} + {N}_{t} - 1 )\end{matrix} ] & ( 9 ) \\ and & \\ Y = [ \begin{matrix}y ( {t}_{0} ) \\ ⋮ \\ y ( {t}_{0} + {N}_{t} - 1 )\end{matrix} ] & ( 10 )\end{matrix}$$

In Equations (9) and (10), to is the data sampling starting time and Nₜ is the number of samples.

In relation to the brightness (contrast) curve m(t) 304, and the brightness (contrast) curve b(t) 306,

$$φ ( t ) = [ \begin{matrix}- m ( t - 1 ) \\ ⋮ \\ - m ( t - na ) \\ u ( t - nk ) \\ ⋮ \\ u ( t - nk - nb + 1 )\end{matrix} ] and$$

$$φ ( t ) = [ \begin{matrix}- b ( t - 1 ) \\ ⋮ \\ - b ( t - na ) \\ u ( t - nk ) \\ ⋮ \\ u ( t - nk - nb + 1 )\end{matrix} ] respectively .$$

In this particular case, u(t) is a step function. And the corresponding solutions are \hat{θ}ₘ and \hat{θ}_{b}. The computation of \hat{θ} realizes the step of dynamic system identification 210 (also step 408 of FIG. 10).

Referring again to FIG. 8, in order to classify a region (classification step 214) with high contrast brightness in MRI images as benign or malignant tumor, a supervised learning step 218 is provided.

A supervised learning is defined as a learning process in which the exemplar set consists of pairs of inputs and desired outputs. In this MRI image breast tissue classification case, the exemplar inputs are \hat{θ}ₘ and \hat{θ}_{b} (or the known curves), the exemplar desired outputs are indicators Oₘ and O_{b} for malignant and benign tumors respectively. In FIG. 8, step 218 receives M sample breast MRI dynamic curves with known characteristics (benign or malignant) from step 216. An exemplary value for M could be 100. Within the M curves, there are Mₘ curves belong to malignant tumors and M_{b} curves belong to benign tumors. Exemplary values for Mₘ and M_{b} could be 50 and 50. In step 218, applying Equation (8) to all the sample curves generates M coefficient vectors \hat{θ}among which, Mₘ coefficient vectors (denoted by \hat{θ}ₘⁱ, i=1 . . . Mₘ) represent malignant tumor with indicator Oₘ, and M_{b} coefficient vectors (denoted by \hat{θ}_{b}ⁱ, i=1 . . . M_{b}) represent benign tumor with indicator O_{b}. These learned coefficient vectors \hat{θ}ₘⁱ and \hat{θ}_{b}ⁱ are used to train a classifier that in turn is used to classify a dynamic contrast curve in a detection or diagnosis process.

To increase the specificity (accuracy in differentiating benign tumors from malignant tumors) other factors (step 220) can be incorporated into the training (learning) and classification process. It is known that factors such as the speed of administration of the contrast agent, timing of contrast administration with imaging, acquisition time and slice thickness (refer to “Contrast-enhanced breast MRI: factors affecting sensitivity and specificity”, by C. W. Piccoli, Eur. Radiol. 7 (Suppl. 5), S281-S288 (1997)).

Denote the speed of administration of the contrast agent by α, the timing of contrast administration with imaging by β, the acquisition time by γ and slice thickness by δ. These exemplary factors are to be used in conjunction with the coefficient vectors \hat{θ}ₘⁱ and \hat{θ}_{b}ⁱ to train the classify that that in turn is used to classify a region in the MRI breast image into malignant or benign tumor classes. Noted that these exemplary factors should be quantified in a range comparable to that of the coefficient vectors \hat{θ}ₘⁱ and \hat{θ}_{b}ⁱ.

For the learning and training purpose, construct the training data set
{pⱼτⱼ}, j=1 . . . l, τⱼ={−1,1},pⱼ∈^{d} (11)
wherein τⱼ are the class labels.

For example, if the tumor is malignant, τⱼ=1, otherwise, τⱼ=−1. The vector pⱼ =[\hat{θ},α,β,γ,δ] is traditionally called feature vector in computer vision literature. The notion [symbol] ^{d} represents a domain, d is the domain dimension. For this exemplary case, assume that the coefficient vector θ has five elements, then d=9. The data format in Equation (11) is used in supervised leaning step 218 as well as in classification step 214. Those skilled in the art will recognize that the data vector pⱼ can be constructed in a different manner and augmented with different physical or non-physical numerical elements (factors) other than the ones aforementioned.

There are known types of classifiers that can be used to accomplish the task of differentiating malignant tumors from benign tumors with the use of dynamic contrast curves along with other physical or non-physical factors. An exemplary classifier is an SVM (support vector machine) (refer to “A Tutorial on Support Vector Machines for Pattern Recognition”, by C. Burges, Data Mining and Knowledge Discovery, 2(2), 1-47, 1998, Kluwer Academic Publisher, Boston, with information available at the website http ://aya.technion.ac.il/karniel/CMCC/SVM-tutorial.pdf).

An example case of an SVM classifier would be training and classification of data representing two classes that are separable by a hyper-plane. A hyper-plane that separates the data satisfies
w•p+σ=0 (12)
where • is a dot product.

The goal of training the SVM is to determine the free parameter w and σ. A scaling can always be applied to the scale of w and σ such that all the data obey the paired inequalities:
τⱼ(w·pⱼ+σ)−1≧0, ∀j (13)
Equation (13) can be solved by minimizing a Lagrangian function

$$L ( w , ξ ) = \frac{1}{2} {‖ w ‖}^{2} - {\sum }_{j = 1}^{l} {ξ}_{j} ( {τ}_{j} ( w \cdot {p}_{j} + σ ) ) \qquad ( 14 )$$

with respect to the parameter w, and maximize it with respect to the undetermined multipliers ξⱼ≧0.

After the optimization problem has been solved, the expression for w in Equation (13) can be rewritten in terms of the support vectors with non-zero coefficients, and plugged into the equation for the classifying hyper-plane to give the SVM decision function:

$$Ψ ( {p}_{new} ) = ( w \cdot {p}_{new} + σ ) = {\sum }_{j = 1}^{{l}_{s}} {τ}_{j} {ξ}_{j} {p}_{j} \cdot {p}_{new} + σ \qquad ( 15 )$$

wherein lₛ is the number of support vectors. Classification of a new vector p_{new} into one of the two classes (malignant and benign) is based on the sign of the decision function. Those skilled in the art will recognize that in non-separable case, non-linear SVMs can be used.

The above described method of tissue property inspection of a set of images (also steps 804 and 808) is applied to all the cross-time image sequences such 704 and 724 for cross-time tissue property inspection. It is understood that in the present invention, the cross-time image sequences are subject to the steps of intra-registration and inter-registration before entering step 808. One exemplary execution procedure of the steps of intra-registration and inter-registration for the sequences is applying intra-registration to sequence 704 first, then applying inter-registration to sequences 704 and 724. Those skilled in the art will recognize that the roles of sequences 704 and 724 are exchangeable.

For intra-registration sequence 704 for this particular exemplary execution procedure, select arbitrarily a set of images as the reference image set, e.g. set 706. Images of set 706 are then input to terminal B (1034 of FIG. 5), other image sets (e.g., 708 and 710) are input to terminal A (1032 of FIG. 5). The registered images of image sets (708 and 710) are obtained at terminal D (1036 of FIG. 5).

For inter-registration for this particular exemplary execution procedure, images of sequence 724 are input to terminal A (1032 of FIG. 5), images of sequence 704 are input to terminal B (1034 of FIG. 5) and the registered images of sequence 724 are obtained at output terminal D (1036 of FIG. 5).

On the completion of step 808 (FIG. 4), multiple dynamic curves (two curves in the current exemplary case) are generated reflecting tissue properties captured in multiple cross-time image sequences (e.g., two sequences 704 and 724 for the current exemplary case) at multiple time instances (two for the current exemplary case). It is known that these dynamic curves provide medical professionals with valuable information regarding disease conditions (or progressions) for patients.

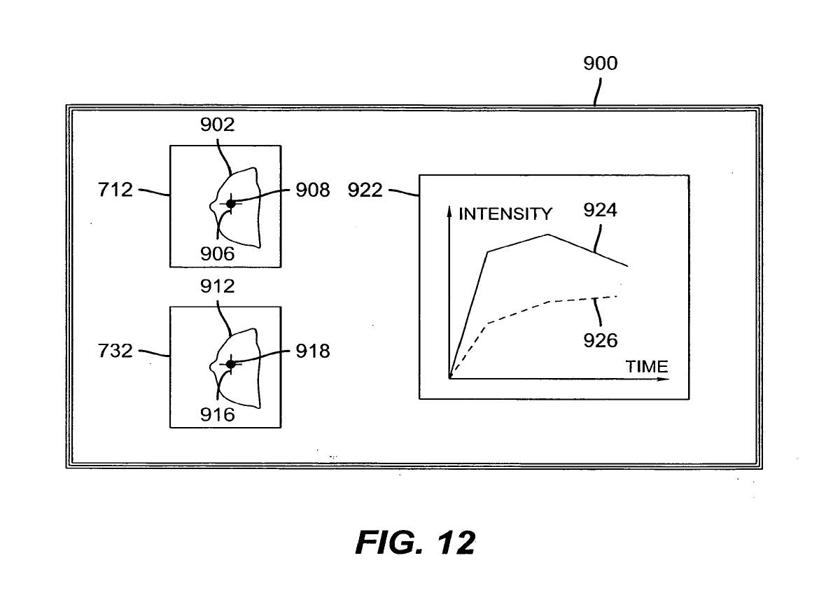

In step 810, visualization tools are employed for medical professionals to examine concerned regions of the object (regions of interest in the images) for better diagnosis. One embodiment of such visualization facility is illustrated in FIG. 12.

There is shown in FIG. 12 a computer monitor screen 900 (which can correspond with display 104 in FIG. 2) in communication with an image processor (which can correspond with image processor 102 of FIG. 2) adapted to practice the method steps described.

On screen 900 are illustrated two representative image slices 712 and 732, shown on the left portion of the screen. For example, slice 712 is the first image of Iₖ(x, y, 1)|k ∈[1,2,3] across three sets (706, 708 and 710) at spatial location 1; slice 732 is the first image of Iₖ(x, y, 1)|k ∈[1,2,3] across three sets (726, 728 and 730) at spatial location 1. Breast images 902 and 912 are shown in slices 712 and 732, respectively. Breast images 902 and 912 are the images of a same cross-section of a breast.

In operation, a medical professional navigates the image (for example, by moving a computer mouse 108 or other user interface) to move an indicator 906 over a location 908 in slice 712. Simultaneously, a ghost indicator 916 appears at the same spatial location 918 in slice 732 (i.e., same spatial location as 908 in slice 712). Alternatively, a user can also move indicator 916 (as a user interface) over location 918 in slice 732, and simultaneously, ghost mouse 906 appears at the same spatial location 908 in slice 712 as 918 in slice 732.

With either arrangement, two dynamic curves (solid curve 924 and dashed curve 926) appear in a chart 922 on display 900. Exemplary curves 924 and 926 reflect different tissue properties for the same spot of a breast at two different times. For example, image sequence containing slice 712 can be taken 6 months prior to capturing the sequence containing slice 732. The medical professional can move the mouse to other locations to examine the change of the tissue properties over a period of time (e.g., 6 months). With this visualization facility, disease progression can be readily analyzed.

Those skilled in the art will understand that tissue properties can be represented by other means in addition to illustrated dynamic curve plots 924 and 926. For example, tissue properties can be represented by colored angiogenesis maps. Those skilled in the art will also understand that multiple cross-time image sequences can be processed by the method of the current invention and multiple dynamic curves can be displayed simultaneously for medical diagnosis.

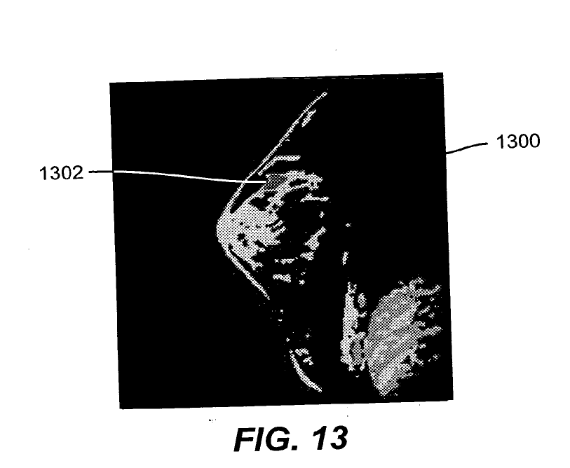

The classification of tissues of different properties enables the generation of special graphs such as angiogenesis maps. In FIG. 13, there is shown an exemplary breast angiogenesis map 1300 that includes a suspicious tumor region 1302 and other tissue regions. In this exemplary map, region 1302 is a region of interest (ROI) for further inspection (e.g. quantitative analysis), and the remaining other regions are considered to be non-ROIs.

In other situations there can be multiple ROIs to be analyzed. However, for ease of convenience, breast angiogenesis map 1300 will be used to describe the process of cross-time, cross-modality inspection of the present invention. Those skilled in the art will understand that the method of the present invention is applicable to other imaging modalities (PET, CT, US, and the like), to other signal (information) formats, and/or to other diseases.

Referring again to FIG. 3, methods steps 1204, 1026 and 1208 are now discussed with particular detail.

In breast cancer diagnosis, X-ray mammography has limited specificity and sensitivity. MRI mammography, as an alternative imaging method, has a sensitivity for tumors larger than a certain size. It can be beneficial for medical practitioners and researchers to examine both X-ray mammography and MRI images to gain complementary information. For example, micro-calcifications best captured by conventional X-ray images.

In FIG. 3, step 1202 acquires cross-time MRI image sequences as one modality, and step 1204 acquires cross-time X-ray mammograms as another modality. There is shown in FIG. 7, along with the cross-time MRI sequences 704 and 724, two exemplary X-ray mammographic images 705 and 725 taken, respectively, at about the same time instances when sequences 704 and 724 are collected. These two mammographic images are to be used in steps 1206 and 1208 for cross-modality analysis.

It is understood that X-ray mammographic images 705 and 725 are projections of a three dimensional object (e.g., breast), while image sequences 704 and 724 are composed of two dimensional slices that are images of cross sections of the three dimensional object (breast).

To facilitate cross-modality examination for data such as 705, 725, 704, and 724, step 1206 of FIG. 12 maps data (images) of one modality of higher dimensionality (MRI sequences, 704 and 724) to that of another modality of a lower dimensionality (X-ray images, 705 and 725).

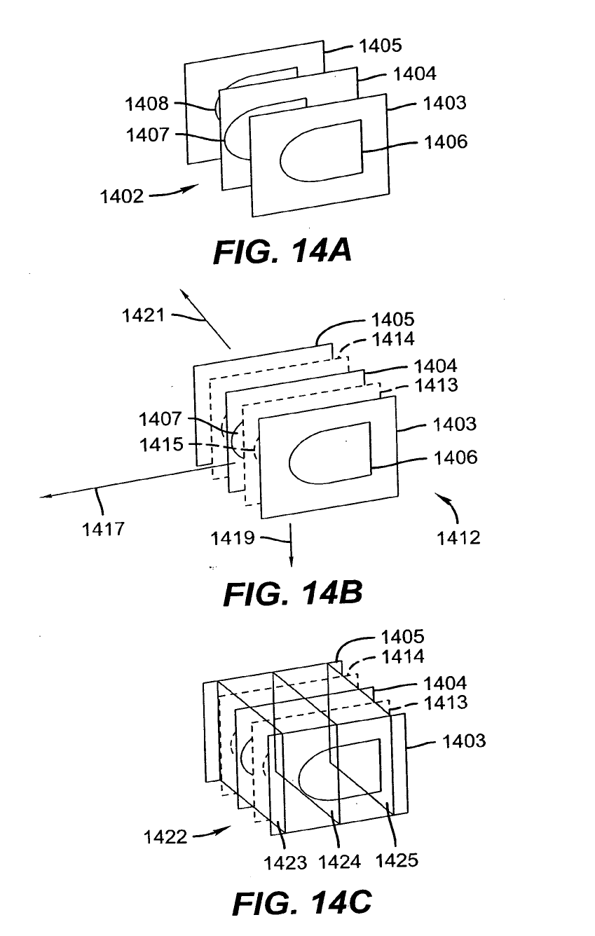

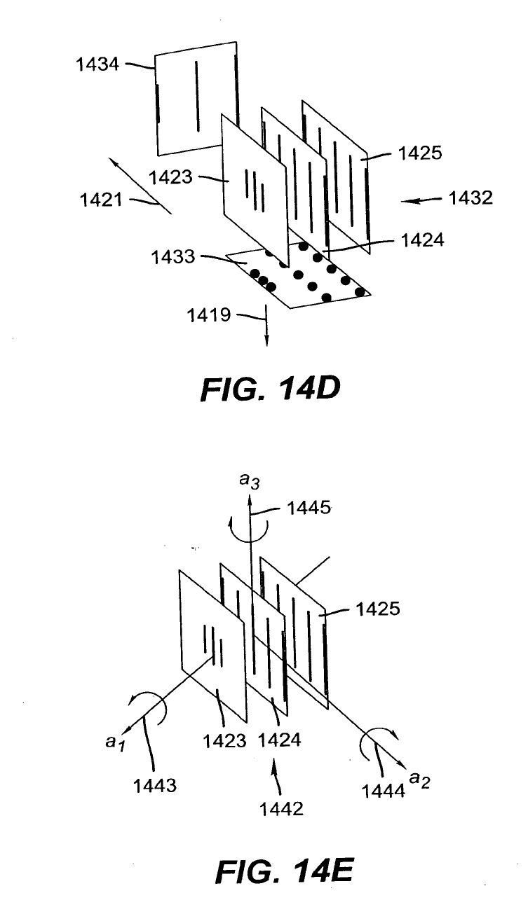

The mapping process (step 1206) of one modality of higher dimensionality to that of another modality of a lower dimensionality is described with reference to the graphs shown in FIGS. 14A-14E.

In FIG. 14A there is shown an exemplary set of MRI slices 1402 similar to the image sets such as 706 or 726 in FIG. 7. For discussion purposes, set 1402 has three slices 1403, 1404, and 1405 with breast images 1406, 1407 and 1408, respectively. In general, three dimensional medical imaging devices produces image slices wherein a distance between neighboring pixels in a slice is often smaller than the center-to-center slice separation. Therefore, the voxel dimensions are generally not isotropic, which is not desirable in most medical image analysis applications. A step is thus taken in the present invention to perform slice interpolation to make the acquired image set (such as set 1402) be isotropic or sufficiently close to isotropic so that cross-modality mapping can be effectively performed. Accordingly, included in the present invention is a slice interpolation method that generates an arbitrary number of new slices between two existing slices so that the property of isotropic can be obtained. The formula of slice interpolation can be expressed as:
Iᵢₙₜ=βI_{1-β}(i→j)+(1−β)I_{β}(j→i) (16)
where Iᵢₙₜ is an interpolated slice, I_{1-β}(i→j) and I_{β}(j→i) are two intermediate slices that generate Iᵢₙₜ. Slices I_{1-β}(i→j) and I_{β}(j→i) are obtained through the method of pseudo-cross-registration of two original neighboring slices I(i) and I(j). The coefficients β and 1−β control the amount of contributions of two intermediate slices toward the interpolated slice. The roles of the subscripts β and 1−β will be understood in the discussion of partial displacement maps and pseudo registration process below. For example, shown in FIG. 14B, slice 1413 is an exemplary Iᵢₙₜ, slice 1403 is an exemplary I(i) and slice 1404 is an exemplary I(j).

The method of pseudo-cross-registration of two slices for slice interpolation of the present invention is now described.

Recall in Equation (10) for image registration, the transformation function Φ generates two displacement maps, X(i, j), and Y(i, j), which include the information that could bring pixels in the source image to new positions that align with the corresponding pixel positions in the reference image.

In the practice of generating an interpolated slice Iᵢₙₜ(such as slice 1413) somewhere between two slices (such as 1403 and 1404), partial displacement maps X_{α}(i, j) and Y_{α}(i, j) are introduced. The partial displacement maps will bring pixels in the source image (slice), I(x) , to new positions that are somewhere between the source image pixels and the corresponding pixel positions in the reference image I(y) . The partial displacement maps X_{α}(i, j) and Y_{α}(i, j) are computed with a pre-determined factor α of a particular value as:
Y_{α}(i, j)=αY(i, j)
X_{α}(i, j)=αX(i, j)
   where 0≦α≦1.

The generated partial displacement maps are then used to deform the source image to obtain intermediate image (slice) Iₐ(x→y) computed as:
I_{α}(x→y)=alignₚₐᵣₜᵢₐₗ(I(x),I(y),α)
where alignₚₐᵣₜᵢₐₗ(I(x),I(y),α) is a function that performs a pseudo registration (alignment) for the source and reference images by using the control parameter α that modifies the original displacement maps X(i, j), and Y(i, j) to X_{α}(i, j) and Y_{α}(i, j).

The above process, pseudo registration, is applied, in turn, to both original slices (e.g., 1403 and 1404) with different control parameters as shown in Equation (16). This generates an intermediate slice (e.g. 1413) that has information from both original slices. Therefore each of the original slices acts as a reference image and a source image. Hence, the term “pseudo-cross-registration” is employed.

In FIG. 14B, slice set 1412 shows two interpolated slices 1413 (with original slices 1403 and 1404) and 1414 (with original slices 1404 and 1405). Since there is only one interpolated slice for every pair of original slices, the parameter β is chosen as 0.5 for this exemplary case. In general, the parameter β is computed as βₖ=k/(N+1), where k ∈[1,2, . . . N] and N is the number of interpolated slices desired. Equation (16) becomes:
Iᵢₙₜ^{βk} =βₖI_{1-β}^{ₖ}(i→j)+(1−βₖ)I_{β}^{ₖ}(j→i).

Illustrative examples of breast images 1406, 1407 and 1408 are shown in slice set 1402. An interpolated breast image 1415 in slice set 1412 illustrates an interpolated breast with a size half way between the sizes of 1406 and 1407. In slice set 1412 there is another interpolated slice 1414 between the original slices 1404 and 1405.

For discussion purposes, slice set 1412 includes an adequate number of interpolated slices between each pair of original slices so that the isotropic voxel requirement is satisfied. Thus, slice set 1412 represents a three-dimensional MRI volume of an object (breast) that needs to be mapped to a lower dimension (2D) space in order to be examined together with the object (breast) representation (X-ray) in the two dimensional space. A mapping from a higher dimension representation to a lower dimension representation involves a projection from a view of interest. For the exemplary breast examination, the commonly accepted views are Cranio-Caudal (CC) view and Medio-Lateral (ML) view for X-ray mammography.

With the digital MRI volume (e.g., interpolated slice set 1412) available, it can be of interest to medical practitioners to have arbitrary views (including the CC and ML views) obtainable by rotating the volume of slice set 1412 about an axis 1417 and then projecting the volume along a direction 1419 (parallel with the vertical edges of the slices) or a direction 1421 (perpendicular to the slices planes). Note that axis 1417 is substantially parallel with a top or bottom edge of the slices and ideally passes through the center of the volume. Practically, axis 1417 passes through the center of the actual object (breast) volume since in general the center of the object volume does not necessarily coincide with the center of the slice volume. The method to find the rotation center (object center) will be discussed later.

Referring to FIG. 14C, one exemplary method of rotating the slice volume around axis 1417 is by re-slicing the volume of slice set 1412 wherein the resultant slices (e.g. 1423, 1424 and 1425 of set 1422) are perpendicular to axis 1417. Rotating individual slices 1423, 1424 and 1425 is substantially equivalent to rotating slice set 1412. These new slices (1423, 1424 and 1425) intersect with slices 1403, 1413, 1404, 1414 and 1405. Breast Images such as 1406, 1415, 1407 and 1408 become lines in 1423, 1424 and 1425. Projecting slices 1423, 1424 and 1425 in direction 1419 results in a graph 1432 with dots shown in image 1433, as shown in FIG. 14D. Projecting slices 1423, 1424 and 1425 in direction 1421 results in an image 1434 with lines shown in graph 1432.

In a more general case, slice set 1412 can be rotated in a roll-pitch-yaw fashion about axes 1443, 1444 and 1445 (see graph 1442 of FIG. 14E) before performing projections. Those skilled in the art will know that another option for obtaining projections from arbitrary angles is to place an imaginary projector in the 3D space and rotate the imaginary projector about the axes 1443, 1444 and 1445 while performing projections of the still slice set 1412.

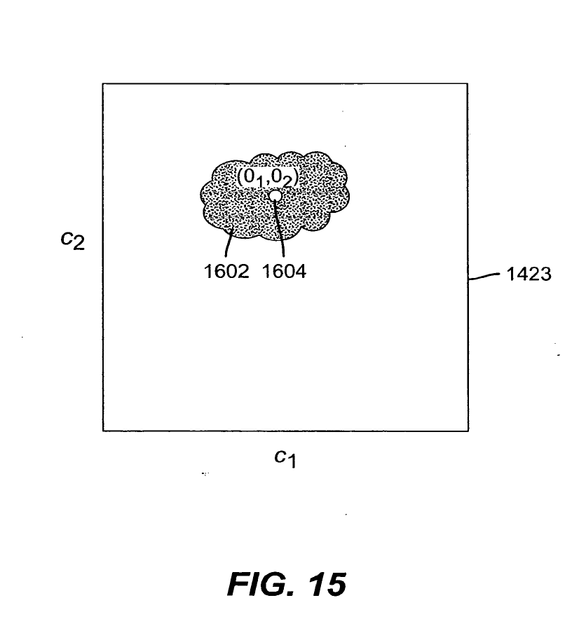

The method to find the rotation center (object center) is described with reference to FIG. 15. An intersection of slice 1423 with the breast images (1406, 1415, 1407, etc.) can result in a cloud of pixels 1602. A center (o₁, o₂) of cloud 1602 is computed by:
o₁=m₁₀/m₀₀
o₂=m₀₁/m₀₀
where the moments m_{pq} are computed as:

$${m}_{pq} = {\int }_{- ∞}^{∞} {\int }_{- ∞}^{∞} {c}_{1}^{p} {c}_{2}^{q} f ( {c}_{1} , {c}_{2} ) ⅆ {c}_{1} ⅆ {c}_{2}$$

where f(c₁, c₂)=1 within cloud 1602 and 0 elsewhere, and c₁ and c₂ are the image coordinates (FIG. 15) in this application.

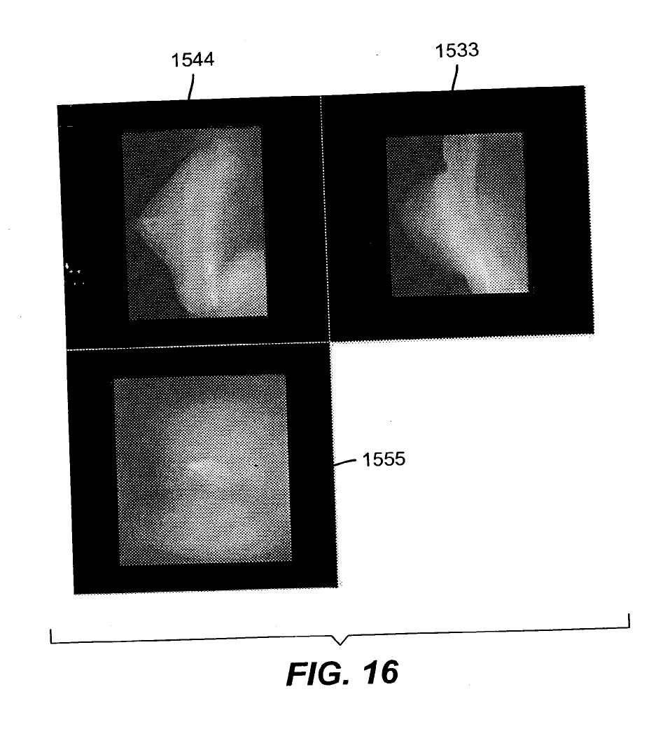

As an example, FIG. 16 shows three projections of an MRI breast volume after slice interpolation. Image 1533 is a projection along the direction 1419, and image 1544 is a projection along direction 1421. There is an additional projection 1555, along direction 1417, which was not discussed previously. Indeed, some medical professionals view this as a least desirable projection direction.

After projecting 3D volumes to the 2D space, the mapping process registers the resultant projections (e.g. images 1533 and 1544) with images acquired directly in 2D space (such as X-ray mammograms 705). It is noted that the 3D volume involved in mapping (projection and registration) can be the original unprocessed slices (such as slice set 706), or the 3D volume composed of angiogenesis images (such as map 1300).

For performing cross-time cross-modality inspection, projections of 3D volume (such as slice set 706 or 716) need to be registered with images (such as 705 or 725). In addition, projections of 706 and 716 need to be registered to each other. Furthermore, images 705 and 725 need to be registered to each other as well. These necessary registrations facilitate performing interactive cross-time cross-modality inspection in step 1208, which is explained using an exemplary scenario next.

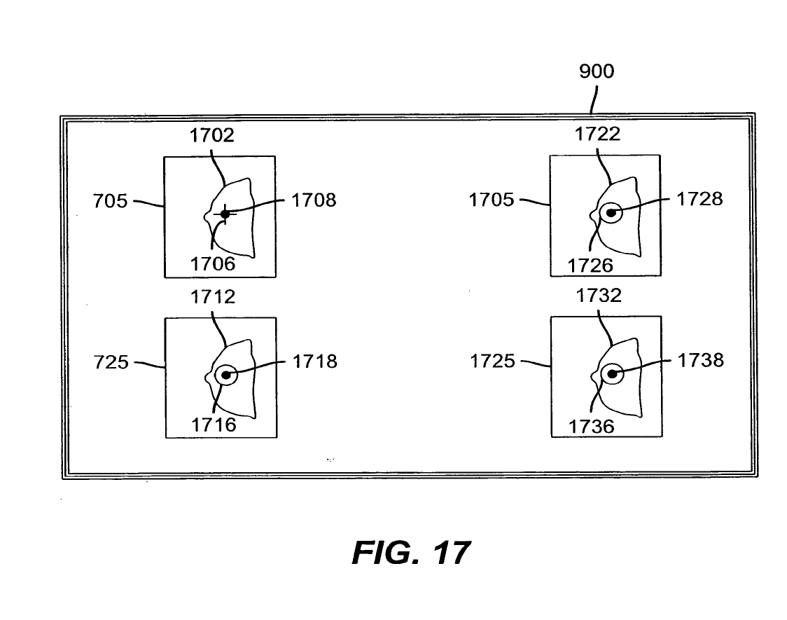

There is shown in FIG. 17 a computer monitor screen 900 (which can correspond with display 104 in FIG. 2) in communication with an image processor (102) that executes previously described steps. Displayed on screen 900 are two representative cross-time 2D images (mammograms) 705 and 725 are. For example, image 705 is captured 6 months before image 725 is captured for the same object (a breast). Images 705 and 725 are registered to each other after the acquisition. Also displays on screen 900 are two cross-time MRI volume projections 1705 and 1725. Practical examples of projections were shown in FIG. 16. Similarly, cross-time volume projections 1705 and 1725 are registered to each other. Moreover, they are registered with 705 and 725 as well.

In an exemplary operation of cross-time cross-modality inspection, a medical professional moves an indictor 1706 (such as a mouse provided through a user interface) over a location 1708 of breast 1702 in image 705. Substantially simultaneously, a marker such as circle 1716 is displayed around the same spatial location 1718 of breast 1712 in image 725 as 1708 in image 705. In addition, a circle 1726 appears around the same spatial location 1728 of breast 1722 in image 1705 as 1708 in image 705. Still further, a circle 1736 appears around the same spatial location 1738 of breast 1732 in image 1705 as 1708 in image 705. In practice, the medical practitioner can select a spot (location/region) of interest in any one of the images (slices) involved in cross-time cross-modality inspection, corresponding spots (regions) will be highlighted with a marker (such as a circle or a square or other form) in all the other images (slices) for pathological analysis. As was shown in FIG. 9, it can be desirable for two dynamic curves (924 solid and 926 dashed) to appear on screen 900, wherein exemplary curves 924 and 926 reflect different tissue properties for the same spot of a breast at two different times.

The method of cross-time cross-modality inspection of the present invention can be implemented in a stand-alone CAD (computer aid diagnosis) workstation, or in a PACS (picture archiving and communication system). The inspection results can be transmitted through a secured network link or through secured wireless communication.

The subject matter of the present invention relates to digital image processing and computer vision technologies, which is understood to mean technologies that digitally process a digital image to recognize and thereby assign useful meaning to human understandable objects, attributes or conditions, and then to utilize the results obtained in the further processing of the digital image.

A computer program for performing the method of the present invention can be stored in a computer readable storage medium. This medium may comprise, for example: magnetic storage media such as a magnetic disk (such as a hard drive or a floppy disk) or magnetic tape; optical storage media such as an optical disc, optical tape, or machine readable bar code; solid state electronic storage devices such as random access memory (RAM), or read only memory (ROM); or any other physical device or medium employed to store a computer program. The computer program for performing the method of the present invention may also be stored on computer readable storage medium that is connected to the image processor by way of the Internet or other communication medium. Those skilled in the art will readily recognize that the equivalent of such a computer program product may also be constructed in hardware.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims.

1. A method for cross-time and cross-modality medical image analysis, comprising:
accessing a first set of medical images of a subject captured at a first time period by a first modality;
accessing a second set of medical images of the subject captured at a second time period by a second modality, the first and second sets each being comprised of a plurality of medical images;
performing image registration by mapping the plurality of medical images of the first and second sets to predetermined spatial coordinates;
performing cross-time image mapping of the first and second sets; and
providing means for interactive cross-time medical image analysis.

2. The method of claim 1, wherein the step of performing image registration comprises:
performing intra-registration of the plurality of medical images of the first and second sets; and
performing inter-registration of the plurality of medical images of the first and second sets.

3. The method of claim 1, further comprising performing tissue property inspection of at least one of the images of the first and second sets.

4. The method of claim 1, further comprising:
accessing a reference set of medical images of the subject;
differencing the first and second sets with the reference set to generate a difference image set comprised of a plurality of images;
segmenting the plurality of images of the difference image set to generate a plurality of images having segmented intensity pixels;
applying a system identification to the plurality of images having segmented intensity pixels to generate a plurality of system parameters; and
classifying the plurality of system parameters.

5. The method of claim 4, further comprising, prior to classifying the plurality of system parameters, augmenting the system parameters with physical or non-physical factors.

6. The method of claim 1, further comprising, after performing image registration, classifying tissues of different properties.
